(19) United States
(12) Patent Application Publication
(10) Pub. No.: US 2003/0118495 A1
(43) Pub. Date: Jun. 26, 2003

(54) Desulfurization and novel sorbent for same

(76) Inventors: Gyanesh P. Khare, Kingwood, TX (US); Donald R. Engelbert, Copan, OK (US)

Correspondence Address: RICHMOND, HITCHCOCK, FISH & DOLLAR, P.O. Box 2443, Bartlesville, OK, 74005, US

(21) Appl. No.: 10/027,192

(22) Filed: Dec. 20, 2001

(51) Int. Cl. B01J 20/02; C10G 29/04; C10G 25/00

(52) U.S. Cl. 423/244.01; 502/400; 502/407; 502/415; 208/243; 208/246; 208/249; 208/299; 208/305

(57) ABSTRACT

A sorbent composition comprising a reduced-valence promoter and a steam-treated support can be used to desulfurize a hydrocarbon-containing fluid such as cracked-gasoline or diesel fuel.

### BACKGROUND OF THE INVENTION

This invention relates to a sorbent composition, a process of making a sorbent composition, and a process of using a sorbent composition for the removal of sulfur from a hydrocarbon-containing fluid.

Hydrocarbon-containing fluids such as gasoline and diesel fuels typically contain a quantity of sulfur. High levels of sulfur in such automotive fuels is undesirable because oxides of sulfur present in automotive exhaust may irreversibly poison noble metal catalysts employed in automobile catalytic converters. Emissions from such poisoned catalytic converters may contain high levels of non-combusted hydrocarbons, oxides of nitrogen, and/or carbon monoxide, which, when catalyzed by sunlight, form ground level ozone, more commonly referred to as smog.

Much of the sulfur present in the final blend of most gasolines originates from a gasoline blending component commonly known as “cracked-gasoline.” Thus, reduction of sulfur levels in cracked-gasoline will inherently serve to reduce sulfur levels in most gasolines, such as, automobile gasolines, racing gasolines, aviation gasolines, boat gasolines, and the like.

Many conventional processes exist for removing sulfur from cracked-gasoline. However, most conventional sulfur removal processes, such as hydrodesulfurization, tend to saturate olefins and aromatics in the cracked-gasoline and thereby reduce its octane number (both research and motor octane number). Thus, there is a need for a process wherein desulfurization of cracked-gasoline is achieved while the octane number is maintained.

In addition to the need for removing sulfur from cracked-gasoline, there is also a need to reduce the sulfur content in diesel fuel. In removing sulfur from diesel fuel by hydrodesulfurization, the cetane is improved but there is a large cost in hydrogen consumption. Such hydrogen is consumed by both hydrodesulfurization and aromatic hydrogenation reactions. Thus, there is a need for a process wherein desulfurization is achieved without a significant consumption of hydrogen so as to provide a more economical process for the desulfurization of hydrocarbon-containing fluids.

Traditionally, sorbent compositions used in processes for the removal of sulfur from hydrocarbon-containing fluids have been agglomerates utilized in fixed bed applications. Because fluidized bed reactors have advantages over fixed bed reactors such as better heat transfer and better pressure drop, hydrocarbon-containing fluids are sometimes processed in fluidized bed reactors. Fluidized bed reactors generally use sorbents that are in the form of relatively small particulates. The size of these particulates is generally in the range of from about 1 micrometer to about 1000 micrometers. However, conventional sorbents generally do not have sufficient attrition resistance (i.e., resistance to physical deterioration) for all applications. Consequently, finding a sorbent with sufficient attrition resistance that removes sulfur from these hydrocarbon-containing fluids and that can be used in fluidized, transport, moving or fixed bed reactors is desirable and would be of significant contribution to the art and to the economy.

### SUMMARY OF THE INVENTION

It is thus an object of the present invention to provide a novel sorbent system for the removal of sulfur from hydrocarbon-containing fluid streams such as cracked-gasoline and diesel fuels.

A further object of the present invention is to provide a novel sorbent composition having enhanced attrition resistance.

Another object of this invention is to provide a method of making a novel sorbent which is useful in the desulfurization of such hydrocarbon-containing fluid streams.

Still another object of this invention is to provide a process for the removal of sulfur-containing compounds from hydrocarbon-containing fluid streams which minimizes saturation of olefins and aromatics therein.

A still further object of this invention is to provide a process for the removal of sulfur-containing compounds from hydrocarbon-containing fluid streams which minimizes hydrogen consumption.

It should be noted that the above-listed objects need not all be accomplished by the invention claimed herein and other objects and advantages of this invention will be apparent from the following description of the invention and appended claims.

In one aspect of the present invention, there is provided a novel sorbent composition suitable for removing sulfur from a hydrocarbon-containing fluid. The sorbent composition comprises a reduced-valence promoter and a steam-treated support.

In accordance with another aspect of the present invention, there is provided a process of making a sorbent composition. The process comprises: admixing a first support component and a second support component so as to form a support mix; particulating the support mix so as to form a support particulate; steam-treating the support particulate to provide a steam-treated particulate; incorporating the steam-treated particulate with a promoter to provide a promoted particulate comprising an unreduced promoter; and reducing the promoted particulate to provide a reduced sorbent composition comprising a reduced-valence promoter.

In accordance with a further aspect of the present invention, there is provided a process for removing sulfur from a hydrocarbon-containing fluid stream. The process comprises the steps of: contacting the hydrocarbon-containing fluid stream with a sorbent composition comprising a reduced-valence promoter and a steam-treated support in a desulfurization zone under conditions such that there is formed a desulfurized fluid stream and a sulfurized sorbent; separating the desulfurized fluid stream from the sulfurized sorbent; regenerating at least a portion of the separated sulfurized sorbent in a regeneration zone so as to remove at least a portion of the sulfur therefrom and provide a desulfurized sorbent; reducing the desulfurized sorbent in an activation zone to provide a reduced sorbent composition which will effect the removal of sulfur from the hydrocarbon-containing fluid stream when contacted with the same; and returning at least a portion of the reduced sorbent composition to the desulfurization zone.

### BRIEF DESCRIPTION OF THE DRAWINGS

FIG. 1 is a schematic flow diagram showing an apparatus for testing the attrition resistance of particulates such as, for example, the inventive sorbent particulates of the present invention.

FIG. 2 is a section view taken along line 2-2 in FIG. 1.

FIG. 3 is a section view taken along line 3-3 in FIG. 2.

### DETAILED DESCRIPTION OF THE INVENTION

In accordance with a first embodiment of the present invention, a novel sorbent composition suitable for removing sulfur from hydrocarbon-containing fluids is provided. The sorbent composition generally comprises a steam-treated support and a reduced-valence promoter.

The support may be any component or combination of components which can be used as a support for the sorbent composition of the present invention to help promote the desulfurization process of the present invention. Examples of suitable support components include, but are not limited to, zinc oxide and any suitable inorganic and/or organic carriers. Preferably, the support is an active component of the sorbent composition. Examples of suitable inorganic carriers include, but are not limited to, silica, silica gel, alumina, diatomaceous earth, expanded perlite, kieselguhr, silica-alumina, titania, zirconia, zinc aluminate, zinc titanate, zinc silicate, magnesium aluminate, magnesium titanate, synthetic zeolites, natural zeolites, and combinations thereof. Examples of suitable organic carriers include, but are not limited to, activated carbon, coke, charcoal, carbon-containing molecular sieves, and combinations thereof A preferred support comprises zinc oxide, silica, and alumina.

When the support comprises zinc oxide, the zinc oxide used in the preparation of the sorbent composition of the present invention can be either in the form of zinc oxide, such as powdered zinc oxide, or in the form of one or more zinc compounds that are convertible to zinc oxide under the conditions of preparation described herein. Examples of suitable zinc compounds include, but are not limited to, zinc sulfide, zinc sulfate, zinc hydroxide, zinc carbonate, zinc acetate, zinc nitrate, and combinations thereof Preferably, the zinc oxide is in the form of powdered zinc oxide. When the support comprises zinc oxide, the zinc oxide will generally be present in the sorbent composition of the present invention in an amount in the range of from about 10 to about 90 weight percent zinc oxide based on the total weight of the sorbent composition, preferably in an amount in the range of from about 15 to about 60 weight percent zinc oxide, and most preferably in an amount in the range of from 20 to 55 weight percent zinc oxide.

When the support comprises silica, the silica used in the preparation of the sorbent composition of the present invention can be either in the form of silica or in the form of one or more silicon compounds. Any suitable type of silica may be employed in preparing the sorbent composition of the present invention. Examples of suitable types of silica include, but are not limited to, diatomite, expanded perlite, silicalite, silica colloid, flame-hydrolyzed silica, hydrolyzed silica, silica gel, precipitated silica, and combinations thereof. In addition, silicon compounds that are convertible to silica such as silicic acid, ammonium silicate and the like and combinations thereof can also be employed. Preferably, the silica is in the form of diatomite or expanded perlite. When the support comprises silica, the silica will generally be present in the sorbent composition of the present invention in an amount in the range of from about 5 to about 85 weight percent silica based on the total weight of the sorbent composition, preferably in an amount in the range of from about 10 to about 60 weight percent silica, and most preferably in an amount in the range of from about 15 to 55 weight percent silica.

When the support comprises alumina, the alumina used in preparing the sorbent composition of the present invention can be present in the source of silica, can be any suitable commercially available alumina material (including, but not limited to, colloidal alumina solutions, hydrated aluminas, and, generally, those alumina compounds produced by the dehydration of alumina hydrates), or both. The preferred alumina is a hydrated alumina such as, for example, boehmite or pseudoboehmite. When the support comprises alumina, the alumina will generally be present in the sorbent composition of the present invention in an amount in the range of from about 1 to about 30 weight percent alumina based on the total weight of the sorbent composition, preferably in an amount in the range of from about 5 to about 20 weight percent alumina, and most preferably in an amount in the range of from 5 to 15 weight percent alumina.

It is preferred that the support comprises zinc aluminate, with such zinc aluminate being formed from at least a portion of the zinc oxide component and at least a portion of the alumina component when the support is subjected to the steam-treatment step, described below. When the support comprises zinc aluminate, the zinc aluminate will generally be present in the sorbent composition of the present invention in an amount in the range of from about 0.1 to about 30 weight percent based on the total weight of the sorbent composition, preferably in an amount in the range of from about 1 to about 20 weight percent.

It is further preferred that the support comprises zinc silicate, with such zinc silicate being formed from at least a portion of the zinc oxide component and at least a portion of the silica component when the support is subjected to the steam-treatment step, described below. When the support comprises zinc silicate, the zinc silicate will generally be present in the sorbent composition of the present invention in an amount in the range of from about 0.1 to about 30 weight percent based on the total weight of the sorbent composition, preferably in an amount in the range of from about 1 to about 20 weight percent zinc silicate.

Optionally, a pore generator component can be used. The pore generator can be any compound that can be mixed with the above components and that is combustible upon heating, thereby producing voids. This pore generator helps to maintain and/or increase the porosity of the sorbent composition. Examples of such pore generators include, but are limited to, cellulose, cellulose gel, microcrystalline cellulose, methyl cellulose, zinc stearate, and graphite. The amount of the pore generator component used in the invention is in the range of about 0.1 to about 15 weight percent based on the total weight of the support. However, an amount in the range of about 1 to about 10 weight percent is preferred, and an amount in the range of about 3 to about 6 weight percent is most preferred.

The promoter can be any component which can be added to the sorbent composition of the present invention to help promote the desulfurization process. The promoter is preferably a metal or metal oxide. As used herein, the term “metal” denotes metal in any form such as elemental metal or a metal containing compound. As used herein, the term “metal oxide” denotes metal oxide in any form such as a metal oxide or a metal oxide precursor.

The metal or metal component of the metal oxide is preferably selected from the group consisting of nickel, cobalt, iron, manganese, copper, zinc, molybdenum, tungsten, silver, tin, vanadium, antimony, and combinations thereof. More preferably, the metal or metal component of the metal oxide is selected from the group consisting of nickel, cobalt, and combinations thereof. Most preferably, the promoter comprises nickel or nickel oxide. In a preferred method of making the present invention, the sorbent composition is promoted with a precursor of nickel oxide such as nickel nitrate, more preferably nickel nitrate hexahydrate.

A portion, preferably a substantial portion, of the promoter present in the final sorbent composition is present in a reduced-valence state. Such reduced-valence promoter preferably has a valence which is less than the valence of the promoter in its common oxidized state, more preferably less than 2, most preferably zero.

The promoter will generally be present in the sorbent composition of the present invention in an amount in the range of from about 1 to about 60 weight percent promoter based on the total weight of the sorbent composition, preferably in an amount in the range of from about 5 to about 45 weight percent promoter, and most preferably in an amount in the range of from 10 to 40 weight percent promoter.

Of the total promoter present in the sorbent composition, it is preferred that at least 10 weight percent of the promoter is present as a reduced-valence promoter, more preferable at least 40 weight percent of the promoter is a reduced-valence promoter, and most preferably at least 80 weight percent of the promoter is reduced-valence promoter.

The reduced-valence promoter will generally be present in the sorbent composition of the present invention in an amount in the range of from about 0.5 to about 50 weight percent reduced-valence promoter based on the total weight of the sorbent composition, preferably in an amount in the range of from about 4 to about 40 weight percent reduced-valence promoter, and most preferably in an amount in the range of from 8 to 35 weight percent reduced-valence promoter.

It has unexpectedly been discovered that steam-treating the support particulate either before or after incorporation with the promoter, preferably before incorporation with the promoter, enhances the attrition resistance of the resulting sorbent composition of the present invention while still providing a sorbent composition which is effective for removing sulfur from hydrocarbon-containing fluid streams. As used herein, the term “attrition resistance” shall mean the ability of particulates to resist deterioration into fines (i.e., particles having a mean particle size of less than 20 micrometers). As used herein, the term “mean particle size” refers to the size of particulate material as determined by using a RO-TAP Testing Sieve Shaker, manufactured by W. S. Tyler Inc., of Mentor, Ohio, or other comparable sieves. The material to be measured is placed in the top of a nest of standard eight inch diameter stainless steel frames sieves with a pan on the bottom. The material undergoes sifting for a period of about 10 minutes; thereafter, the material retained on each sieve is weighed. The percent retained on each sieve is calculated by dividing the weight of the material retained on a particular sieve by the weight of the original sample. This information is used to compute the mean particle size.

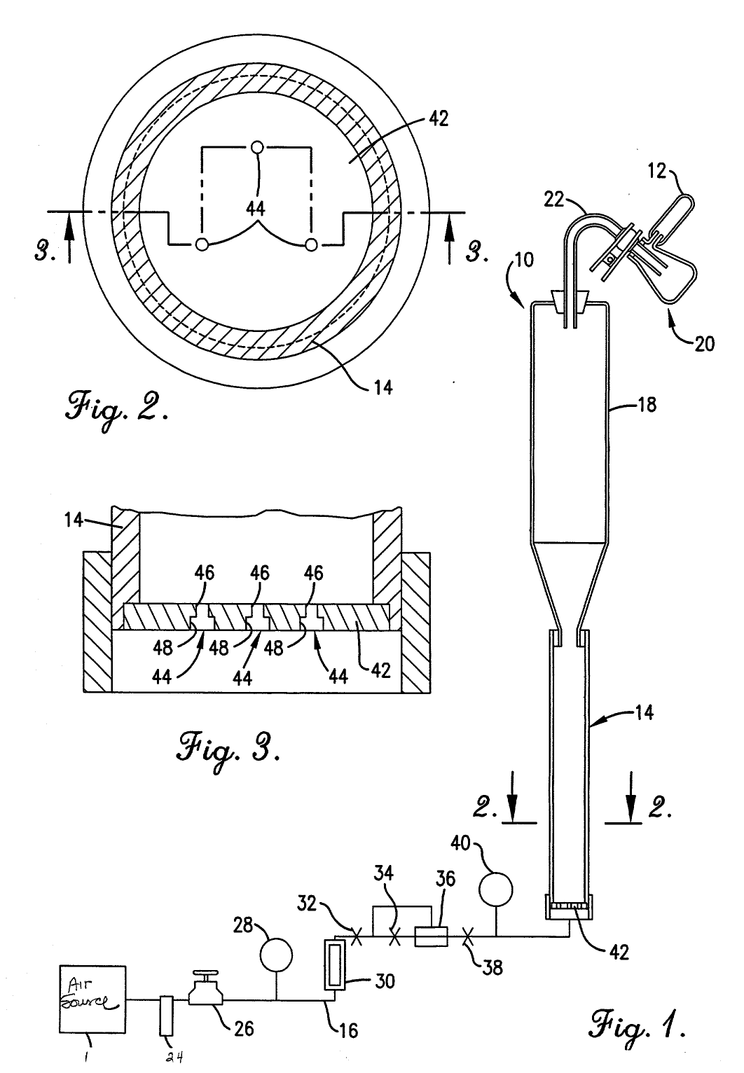

One apparatus and method of determining the attrition resistance of a particulate is disclosed in U.S. Pat. No. 4,010,116, the entire disclosure of which is incorporated herein by reference. A preferred attrition resistance testing apparatus and method is described below with reference to FIGS. 1-3.

Referring now to FIGS. 1-3, attrition resistance testing apparatus 10 generally includes an air source 1 for providing air to a catalyst tube 14 via an air line 16. The air flowing through catalyst tube 14 causes particulates contained in tube 14 to be propelled upwards into a disengagement chamber 18 wherein fines (i.e., minuscule pieces of the particulate which have attrited from the larger particulates) are separated from the larger particulates. The larger particulates fall downward towards catalyst tube 14 while the air causes the fines to move upwards out of disengagement chamber 18 and into a collection vessel 20 via an inverted u-tube 22. Collection vessel 20 includes a filter 12 which allows air to pass therethrough while retaining the fines in collection vessel 20. Various flow control and measurement devices are fluidically interposed in air line 16. Such devices may include, an air filter 24, a pressure regulator 26, a first pressure gauge 28, a rotameter 30, first and second valves 32 and 34, a Moore flow controller 36, a third valve 38, and a second pressure gauge 40. As perhaps best seen in FIGS. 2 and 3, the base of catalyst tube 14 includes a ⅛ inch thick circular perforated plate 42 having three symmetric bores 44 extending therethrough. Each bore 44 includes an upper portion 46 (0.015 inch diameter) and a lower portion 48 (0.0625 inch diameter). Bores 44 act as simplified nozzles to increase the velocity of air as it enters catalyst tube 14. The high velocity air entering catalyst tube 14 causes physical agitation of the particulates contained therein.

To perform the attrition test, collection vessel 10 is first weighed to determine its tare weight. The particulates to be tested are then sieved to remove any fines (i.e., particles less than 20 micrometers or −400 mesh). A 50 gram quantity of the fines-free particulate is then charged to catalyst tube 4. Air source 1 is then actuated and the air pressure is set at 75 psig using rotameter 18. First and third valves 20 and 26 are then opened and second valve 32 is used to adjust the air flow to 15.00±0.1 CF/H at room conditions. The air flowing through attrition testing apparatus 10 causes the particulate to be attrited, thereby producing fines. As the air flows through the system the fines are collected in collection vessel 10. At 1 and 5 hours from the commencement of air flow, collection vessel 10 and the fines contained therein are weighed to obtain a gross weight. The 1-hour and 5-hour percent attrition values are calculated according to the following formula:

$$\% Attrition \text{1,5} = 100 \times \frac{Gross Weight \text{1,5} - Tare Weight}{50}$$

The sorbent composition of the present invention preferably has a 1-hour percent attrition value of less than about 20 percent, more preferably less than 10 percent. The inventive sorbent composition preferably has a 5-hour percent attrition value of less than about 50 percent, more preferably less than about 30 percent, and most preferably less than 25 percent.

In accordance with a second embodiment of the present invention, a process for making the inventive sorbent composition of the first embodiment of the present invention is provided.

In the manufacture of the sorbent composition of the present invention, the support is generally prepared by combining the support components, described above, together in appropriate proportions, described above, by any suitable method or manner known in the art which provides for the intimate mixing of such components to thereby provide a substantially homogeneous mixture comprising the support components, preferably a substantially homogeneous mixture comprising zinc oxide, silica, and alumina. Any suitable means for mixing the support component can be used to achieve the desired dispersion of the components. Examples of suitable means for mixing include, but are not limited to, mixing tumblers, stationary shells or troughs, Muller mixers, which are of the batch or continuous type, impact mixers, and the like. It is presently preferred to use a Muller mixer as the means for mixing the support components.

The support ingredients are contacted together by any manner known in the art to provide a resulting mixture which can be in the form selected from the group consisting of a wet mix, a dough, a paste, a slurry, and the like. Such resulting support mixture can then be shaped to form a particulate(s) selected from the group consisting of a granulate, an extrudate, a tablet, a sphere, a pellet, a micro-sphere, and the like. For example, if the resulting support mixture is in the form of a wet mix, the wet mix can be densified, dried, calcined, and thereafter shaped, or particulated, through the granulation of the densified, dried, calcined mix to form granulates. Also for example, when the resulting support mixture is in the form of either a dough state or paste state, such resulting mixture can then be shaped, preferably extruded, to form a particulate, preferably cylindrical extrudates having a diameter in the range of from about 1/32 inch to ½ inch and any suitable length, preferably a length in the range of from about ⅛ inch to about 1 inch. The resulting support particulates, preferably cylindrical extrudates, are then dried and calcined under conditions as disclosed herein.

More preferably, the resulting support mixture is in the form of a slurry and the particulation of such slurry is achieved by spray drying the slurry to form micro-spheres thereof having a mean particle size generally in the range of from about 1 micrometer to about 500 micrometers, preferably in the range of from about 10 micrometers to about 300 micrometers. Spray drying is known in the art and is discussed in Perry's Chemical Engineers' Handbook, Sixth Edition, published by McGraw-Hill, Inc., at pages 20-54 through 20-58. Additional information can be obtained from the Handbook of Industrial Drying, published by Marcel Dekker. Inc., at pages 243 through 293.

When the particulation is achieved by preferably spray drying, a dispersant can be utilized and can be any suitable compound that helps to promote the spray drying ability of the resulting mixture which is preferably in the form of a slurry which preferably comprises zinc oxide, silica, and alumina. In particular, the dispersant is useful in preventing deposition, precipitation, settling, agglomerating, adhering and caking of solid particles in a fluid medium. Examples of suitable dispersants include, but are not limited to, condensed phosphates, sulfonated polymers, ammonium polyacrylate, sodium polyacrylate, ammonium polymethacrylate, poly(methyl methacrylate), polyacrylic acid (sodium salt), polyacrylamide, and the like and combinations thereof. The term “condensed phosphates” refers to any dehydrated phosphate where the H₂O:P₂O₅ is less than about 3:1. Specific examples of suitable dispersants include, but are not limited to, sodium pyrophosphate, sodium metaphosphate, sulfonated styrene maleic anhydride polymer, and the like and combinations thereof.

The spray dried support particulate can then be dried under a drying condition as disclosed herein and calcined under a calcining condition as disclosed herein. Preferably, calcining is conducted in an oxidizing atmosphere, such as in the presence of oxygen or air, to form a dried and calcined support particulate. The calcination can be conducted under any suitable condition that removes residual water and oxidizes combustibles.

After the support particulate is dried and calcined, it is then subjected to a steam-treatment. This steam-treatment comprises contacting the support particulate with a steam mixture that comprises water and air to produce a steam-treated support particulate. If desired, this mixture can contain other gases such as, for example, nitrogen, helium, and argon. The steam mixture should contain about 5 to about 90 volume percent water, the remainder comprising air. Preferably, the steam mixture should contain about 10 to 80 volume percent water, the remainder comprising air. The steam-treatment should be conducted at a temperature in the range of about 400° C. to about 1,500° C. However, it is preferred if the steam-treatment is conducted at a temperature in the range of about 750° to about 1,000° C. Generally, the amount of time that the steam mixture is contacted with the support particulate will depend on the temperature the steam-treatment is conducted at. However, the amount of time that the steam mixture is contacted with the support particulate is preferably from about 0.5 to about 24 hours and more preferably from about 4 to 10 hours. The steam-treatment can take place either before, or after, incorporating the promoter. Additionally, one or more steam-treatments can be conducted to obtain a desired result.

Preferably, the steam-treatment is carried out under conditions sufficient to convert at least a portion of the zinc oxide and alumina present in the support to zinc aluminate. Preferably, the steam-treatment is carried out under conditions sufficient to convert at least a portion of the zinc oxide and silica present in the support to zinc silicate.

The resulting steam-treated support particulate is then contacted with the promoter to thereby incorporate the promoter with the steam-treated support particulate. The promoter may be incorporated in, on, or with the steam-treated support particulate by any suitable means or method known in the art such as, for example, impregnating, soaking, spraying, and combinations thereof. The preferred method of incorporating the promoter into the steam-treated support particulate is impregnating using standard incipient wetness impregnation techniques. A preferred method uses an impregnating solution comprising the desired concentration of the promoter so as to ultimately provide a promoted particulate which can be subjected to drying, calcining, and reduction to provide the sorbent composition of the present invention. The impregnating solution can be any aqueous solution in amounts of such solution which suitably provides for the impregnation of the steam-treated support particulates. A preferred impregnating solution is formed by dissolving a promoter-containing compound in water. It is acceptable to use somewhat of an acidic solution to aid in the dissolution of the promoter-containing compound. It is more preferred for the support particulates to be impregnated with the promoter by use of a solution containing nickel nitrate hexahydrate dissolved in water.

Generally, the amount of the promoter incorporated, preferably impregnated, onto, into, or with the steam-treated support is an amount which provides, after the promoted particulate material has been dried calcined, and reduced, a sorbent composition having an amount of the reduced-valence promoter as disclosed herein.

Once the promoter has been incorporated in, on, or with the steam-treated support particulate, the promoted particulate is subsequently dried and calcined under conditions disclosed herein to thereby provide a dried, calcined, promoted particulate comprising an unreduced promoter.

Generally, a drying condition, as referred to herein, can include a temperature in the range of from about 180° F. to about 290° F., preferably in the range of from about 190° F. to about 280° F., and more preferably in the range of from 200° F. to 270° F. Such drying condition can also include a time period generally in the range of from about 0.5 hour to about 60 hours, preferably in the range of from about 1 hour to about 40 hours, and more preferably in the range of from 1.5 hours to 20 hours. Such drying condition can also include a pressure generally in the range of from about atmospheric (i.e., about 14.7 pounds per square inch absolute) to about 150 pounds per square inch absolute (psia), preferably in the range of from about atmospheric to about 100 psia, more preferably about atmospheric, so long as the desired temperature can be maintained. Any drying method(s) known to one skilled in the art such as, for example, air drying, heat drying, vacuum drying, and the like and combinations thereof can be used.

Generally, a calcining condition, as referred to herein, can include a temperature in the range of from about 400° F. to about 1800° F., preferably in the range of from about 600° F. to about 1600° F., and more preferably in the range of from 800° F. to about 1500° F. Such calcining condition can also include a time period generally in the range of from about 1 hour to about 60 hours, preferably in the range of from about 2 hours to about 20 hours, and more preferably in the range of from 3 hours to 15 hours. Such calcining condition can also include a pressure, generally in the range of from about 7 pounds per square inch absolute (psia) to about 750 psia, preferably in the range of from about 7 psia to about 450 psia, and more preferably in the range of from 7 psia to 150 psia.

The dried, calcined, promoted particulates are thereafter subjected to reduction with a suitable reducing agent, preferably hydrogen, under reducing conditions, to thereby provide a reduced sorbent composition comprising a reduced-valence promoter having a valence which is less than that of the unreduced promoter. Reduction can be carried out at a temperature in the range of from about 100° F. to about 1500° F. and at a pressure in the range of from about 15 pounds per square inch absolute (psia) to about 1,500 psia. Such reduction is carried out for a time period sufficient to achieve the desired level of promoter reduction. Such reduction can generally be achieved in a time period in the range of from about 0.01 hour to about 20 hours.

In accordance with a third embodiment of the present invention, a desulfurization process is provided which employs the novel sorbent composition described herein.

The hydrocarbon-containing fluid feed employed in the desulfurization process of this embodiment of the present invention is preferably a sulfur-containing hydrocarbon fluid, more preferably, gasoline or diesel fuel, most preferably cracked-gasoline or diesel fuel.

The hydrocarbon-containing fluid described herein as suitable feed in the process of the present invention comprises a quantity of olefins, aromatics, sulfur, as well as paraffins and naphthenes. The amount of olefins in gaseous cracked-gasoline is generally in the range of from about 10 to about 35 weight percent olefins based on the total weight of the gaseous cracked-gasoline. For diesel fuel there is essentially no olefin content. The amount of aromatics in gaseous cracked-gasoline is generally in the range of from about 20 to about 40 weight percent aromatics based on the total weight of the gaseous cracked-gasoline. The amount of aromatics in gaseous diesel fuel is generally in the range of from about 10 to about 90 weight percent aromatics based on the total weight of the gaseous diesel fuel. The amount of sulfur in the hydrocarbon-containing fluid, preferably cracked-gasoline or diesel fuel, suitable for use in a process of the present invention can be in the range of from about 100 parts per million sulfur by weight of the cracked-gasoline to about 10,000 parts per million sulfur by weight of the cracked-gasoline and from about 100 parts per million sulfur by weight of the diesel fuel to about 50,000 parts per million sulfur by weight of the diesel fuel prior to the treatment of such hydrocarbon-containing fluid with the process of the present invention. The amount of sulfur in the desulfurized hydrocarbon-containing fluid following treatment in accordance with the process of the present invention is less than about 100 parts per million (ppm) sulfur by weight of hydrocarbon-containing fluid, preferably less than about 90 ppm sulfur by weight of hydrocarbon-containing fluid, and more preferably less than about 80 ppm sulfur by weight of hydrocarbon-containing fluid.

As used herein, the term “gasoline” denotes a mixture of hydrocarbons boiling in the range of from about 100° F. to about 400° F., or any fraction thereof. Examples of suitable gasoline include, but are not limited to, hydrocarbon streams in refineries such as naphtha, straight-run naphtha, coker naphtha, catalytic gasoline, visbreaker naphtha, alkylate, isomerate, reformate, and the like and combinations thereof.

As used herein, the term “cracked-gasoline” denotes a mixture of hydrocarbons boiling in the range of from about 100° F. to about 400° F., or any fraction thereof, that are products from either thermal or catalytic processes that crack larger hydrocarbon molecules into smaller molecules. Examples of suitable thermal processes include, but are not limited to, coking, thermal cracking, visbreaking and the like and combinations thereof. Examples of suitable catalytic cracking processes include, but are not limited to fluid catalytic cracking, heavy oil cracking, and the like and combinations thereof. Thus, examples of suitable cracked-gasoline include, but are not limited to, coker gasoline, thermally cracked gasoline, visbreaker gasoline, fluid catalytically cracked gasoline, heavy oil cracked gasoline, and the like and combinations thereof. In some instances, the cracked-gasoline may be fractionated and/or hydrotreated prior to desulfurization when used as a hydrocarbon-containing fluid in a process of the present invention.

As used herein, the term “diesel fuel” denotes a mixture of hydrocarbons boiling in the range of from about 300° F. to about 750° F., or any fraction thereof. Examples of suitable diesel fuels include, but are not limited to, light cycle oil, kerosene, jet fuel, straight-run diesel, hydrotreated diesel, and the like and combinations thereof.

As used herein, the term “sulfur” denotes sulfur in any form such as elemental sulfur or a sulfur compound normally present in a hydrocarbon-containing fluid such as cracked gasoline or diesel fuel. Examples of sulfur which can be present during a process of the present invention, usually contained in a hydrocarbon-containing fluid, include, but are not limited to, hydrogen sulfide, carbonyl sulfide (COS), carbon disulfide (CS₂), mercaptans (RSH), organic sulfides (R—S—R), organic disulfides (R—S—S—R), thiophene, substituted thiophenes, organic trisulfides, organic tetrasulfides, benzothiophene, alkyl thiophenes, alkyl benzothiophenes, alkyl dibenzothiophenes, and the like and combinations thereof as well as the heavier molecular weights of same which are normally present in a diesel fuel of the types contemplated for use in a process of the present invention, wherein each R can be an alkyl or cycloalkyl or aryl group containing one carbon atom to ten carbon atoms.

As used herein, the term “fluid” denotes gas, liquid, vapor, and combinations thereof.

As used herein, the term “gaseous” denotes that state in which the hydrocarbon-containing fluid, such as cracked-gasoline or diesel fuel, is primarily in a gas or vapor phase.

The desulfurizing of the hydrocarbon-containing fluid is carried out in a desulfurization zone under a set of conditions that includes total pressure, temperature, weight hourly space velocity, and hydrogen flow. These conditions are such that the sorbent composition can desulfurize the hydrocarbon-containing fluid to produce a desulfurized hydrocarbon-containing fluid and a sulfurized sorbent composition.

In desulfurizing the hydrocarbon-containing fluid, it is preferred that the hydrocarbon-containing fluid, preferably cracked-gasoline or diesel fuel, be in a gas or vapor phase. However, in the practice of the present invention it is not essential that the hydrocarbon-containing fluid be totally in a gas or vapor phase.

In desulfurizing the hydrocarbon-containing fluid, the total pressure can be in the range of from about 15 pounds per square inch absolute (psia) to about 1500 psia. However, it is presently preferred that the total pressure be in a range of from about 50 psia to about 500 psia. In general, the temperature should be sufficient to keep the hydrocarbon-containing fluid in essentially a vapor or gas phase. While such temperatures can be in the range of from about 100° F. to about 1000° F., it is presently preferred that the temperature be in the range of from about 400° F. to about 800° F. when treating a cracked-gasoline and in the range of from about 500° F. to about 900° F. when treating a diesel fuel.

Weight hourly space velocity (WHSV) is defined as the numerical ratio of the rate at which a hydrocarbon-containing fluid is charged to the desulfurization zone in pounds per hour at standard condition of temperature and pressure (STP) divided by the pounds of sorbent composition contained in the desulfurization zone to which the hydrocarbon-containing fluid is charged. In the practice of the present invention, such WHSV should be in the range of from about 0.5 hr⁻¹ to about 50 hr⁻¹, preferably in the range of from about 1 hr⁻¹ to about 20 hr⁻¹. The desulfurizing (i.e., desulfurization) of the hydrocarbon-containing fluid should be conducted for a time sufficient to affect the removal of at least a substantial portion sulfur from such hydrocarbon-containing fluid.

In desulfurizing the hydrocarbon-containing fluid, it is presently preferred that an agent be employed which interferes with any possible chemical or physical reacting of the olefinic and aromatic compounds in the hydrocarbon-containing fluid which is being treated with a sorbent composition of the present invention. Preferably, such agent is hydrogen. Hydrogen flow in the desulfurization zone is generally such that the mole ratio of hydrogen to hydrocarbon-containing fluid is the range of from about 0.1 to about 10, preferably in the range of from about 0.2 to about 3.

If desired, during the desulfurizing of the hydrocarbon-containing fluid according to the process of the present invention, a diluent such as methane, carbon dioxide, flue gas, nitrogen and the like and combinations thereof can be used. Thus, it is not essential to the practice of a process of the present invention that a high purity hydrogen be employed in achieving the desired desulfurization of a hydrocarbon-containing fluid such as cracked-gasoline or diesel fuel.

It is presently preferred, when the desulfurization zone is in a fluidized bed reactor system, that a sorbent composition be used having a mean particle size, as described herein, in the range of from about 1 micrometer to about 500 micrometers. Preferably, such sorbent composition has a mean particle size in the range of from about 10 micrometers to about 300 micrometers. When a fixed bed reactor system is employed as the desulfurization zone of the present invention, the sorbent composition should generally have a particulate size in the range of from about 1/32 inch to about ½ inch diameter, preferably in the range of from about 1/32 inch to about ¼ inch diameter. It is further presently preferred to use a sorbent composition having a surface area in the range of from about 1 square meter per gram to about 1000 square meters per gram (m²/g), preferably in the range of from about 1 m²/g to about 800 m²/g.

After sulfur removal in the desulfarization zone, the desulfurized hydrocarbon-containing fluid and sulfurized sorbent composition can then be separated by any manner or method known in the art that can separate a solid from a fluid, preferably a solid from a gas. Examples of suitable separating means for separating solids and gases include, but are not limited to, cyclonic devices, settling chambers, impingement devices, filters, and combinations thereof. The desulfurized hydrocarbon-containing fluid, preferably desulfurized gaseous cracked-gasoline or desulfurized gaseous diesel fuel, can then be recovered and preferably liquefied. Liquification of such desulfurized hydrocarbon-containing fluid can be accomplished by any manner or method known in the art.

The sulfurized sorbent is then regenerated in a regeneration zone under a set of conditions that includes temperature, total pressure, and sulfur removing agent partial pressure. The regenerating is carried out at a temperature generally in the range of from about 100° F. to about 1500° F., preferably in the range of from about 800° F. to about 1200° F. Total pressure is generally in the range of from about 15 pounds per square inch absolute (psia) to about 500 psia. The sulfur removing agent partial pressure is generally in the range of from about 1 percent to about 100 percent of the total pressure. The sulfur removing agent partial pressure is generally in the range of from about 1 percent to about 100 percent of the total pressure.

The sulfur removing agent, i.e., regenerating agent, is a composition(s) that helps to generate gaseous sulfur-containing compounds and oxygen-containing compounds such as sulfur dioxide, as well as to bum off any remaining hydrocarbon deposits that might be present. The preferred sulfur removing agent, i.e., regenerating agent, suitable for use in the regeneration zone is oxygen or an oxygen-containing gas(es) such as air. Such regeneration is carried out for a time sufficient to achieve the desired level of regeneration. Such regeneration can generally be achieved in a time period in the range of from about 0.1 hour to about 24 hours, preferably in the range of from about 0.5 hour to about 3 hours.

In carrying out the process of the present invention, a stripper zone can be inserted before and/or after, preferably before, regenerating the sulfurized sorbent composition in the regeneration zone. Such stripper zone, preferably utilizing a stripping agent, will serve to remove a portion, preferably all, of any hydrocarbon(s) from the sulfurized sorbent composition. Such stripper zone can also serve to remove oxygen and sulfur dioxide from the system prior to introduction of the regenerated sorbent composition into the activation zone. Such stripping employs a set of conditions that includes total pressure, temperature, and stripping agent partial pressure.

Preferably, the stripping, when employed, is carried out at a total pressure in the range of from about 25 pounds per square inch absolute (psia) to about 500 psia. The temperature for such stripping can be in the range of from about 100° F. to about 1000° F. Such stripping is carried out for a time sufficient to achieve the desired level of stripping. Such stripping can generally be achieved in a time period in the range of from about 0.1 hour to about 4 hours, preferably in the range of from about 0.3 hour to about 1 hour. The stripping agent is a composition(s) that helps to remove a hydrocarbon(s) from the sulfurized sorbent composition. Preferably, the stripping agent is nitrogen.

After regeneration, and optionally stripping, the desulfurized sorbent composition is then subjected to reducing, i.e., activating, in an activation zone with a reducing agent, preferably hydrogen, so that at least a portion of the unreduced promoter incorporated on, in, or with the sorbent composition is reduced to thereby provide a reduced sorbent composition comprising a reduced-valence promoter. Such reduced-valence promoter is incorporated on, in, or with such sorbent composition in an amount that provides for the removal of sulfur from the hydrocarbon-containing fluid according to a process of the present invention.

In general, when practicing a process of the present invention, the reducing, i.e., activating, of the desulfurized sorbent composition is carried out at a temperature in the range of from about 100° F. to about 1500° F. and at a pressure in the range of from about 15 pounds per square inch absolute (psia) to about 1500 psia. Such reduction is carried out for a time sufficient to achieve the desired level of promoter reduction. Such reduction can generally be achieved in a time period in the range of from about 0.01 hour to about 20 hours.

Following the reducing, i.e., activating, of the regenerated, desulfurized sorbent composition, at least a portion of the resulting reduced (i.e., activated) sorbent composition can be returned to the desulfurization zone.

When carrying out the desulfurization process of the present invention, the steps of desulfurizing, regenerating, reducing (i.e., activating), and optionally stripping before and/or after such regenerating, can be accomplished in a single zone or vessel or in multiple zones or vessels. The desulfurization zone can be any zone wherein desulfurizing a hydrocarbon-containing fluid such as cracked-gasoline, diesel fuel or the like can take place. The regeneration zone can be any zone wherein regenerating or desulfurizing a sulfurized sorbent composition can take place. The activation zone can be any zone wherein reducing, i.e., activating, a regenerated, desulfurized sorbent composition can take place. Examples of suitable zones are fixed bed reactors, moving bed reactors, fluidized bed reactors, transport reactors, reactor vessels and the like.

When carrying out the process of the present invention in a fixed bed reactor system, the steps of desulfurizing, regenerating, reducing, and optionally stripping before and/or after such regenerating are accomplished in a single zone or vessel. When carrying out the process of the present invention in a fluidized bed reactor system, the steps of desulfurizing, regenerating, reducing, and optionally stripping before and/or after such regenerating are accomplished in multiple zones or vessels.

When the desulfurized hydrocarbon-containing fluid resulting from the practice of a process of the present invention is a desulfurized cracked-gasoline, such desulfurized cracked-gasoline can be used in the formulation of gasoline blends to provide gasoline products suitable for commercial consumption and can also be used where a cracked-gasoline containing low levels of sulfur is desired.

When the desulfurized hydrocarbon-containing fluid resulting from the practice of a process of the present invention is a desulfurized diesel fuel, such desulfurized diesel fuel can be used in the formulation of diesel fuel blends to provide diesel fuel products suitable for commercial consumption and can also be used where a diesel fuel containing low levels of sulfur is desired.

The following example is presented to further illustrate this invention and is not to be construed as unduly limiting the scope of this invention. Mesh sieve numbers used in the Examples are U.S. Standard Sieve Series, ASTM specification E-11-61.

### EXAMPLE I

Sorbent A (control) was prepared by mixing 20 grams of sodium pyrophosphate (available from Aldrich Chemical Company, Milwaukee, Wis.) and 2224 grams of distilled water in a Cowles dissolver to create a sodium pyrophosphate solution. A 200 gram quantity of aluminum hydroxide powder (Dispal™ Alumina Powder, available from CONDEA Vista Company, Houston, Tex.), a 628 gram quantity of diatomaceous earth (Celite™ Filter Cell, available from Manville Sales Corporation, Lampoc, Calif.), and a 788 gram quantity of zinc oxide powder (available from Zinc Corporation, Monaca, Pa.) were then mixed to form a powdered mixture. The powdered mixture was slowly added to the sodium pyrophosphate solution and mixed for 25 minutes to create a sorbent base slurry. The resulting mixed slurry was sieved through a 25-mesh screen.

The sorbent base slurry was then formed into sorbent base particulate using a counter-current spray drier (Niro Mobile Minor Spray Dryer, available from Niro Atomizer Inc., Columbia, Md.). The sorbent base slurry was charged to the spray drier wherein it was contacted in a particulating chamber with air flowing through the chamber. The air flowing through the particulating chamber had an inlet temperature of about 320° C. and an outlet temperature of about 100° C. The sorbent base particulate was then further dried in an oven by ramping the oven temperature at 3° C./min to 150° C. and holding at 150° C. for 3 hours. The dried sorbent base particulate was then calcined by ramping the oven temperature at 3° C./min to 635° C. and holding at 635° C. for 1 hour.

The calcined sorbent base particulate was then sieved to provide a 100 gram quantity which passed through the 50 mesh sieve but was retained above the 140 mesh sieve (i.e., −50/+140 mesh). The resulting 100 gram quantity of sieved sorbent base particulate was then impregnated with a solution containing 59.42 grams of nickel nitrate hexahydrate and 62.9 grams of distilled water using incipient wetness techniques. The impregnated sorbent was then put in an oven and dried by ramping the oven temperature at 3° C./min to 150° C. and holding at 150° C. for 3 hours. The dried sorbent was then calcined by ramping the oven temperature at 3° C./min to 635° C. and holding at 635° C. for 1 hour. The resulting nickel-promoted sorbent was designated Sorbent A.

Sorbent B (steam-treated) was prepared by mixing 6120 grams of distilled water, 202.5 grams of acetic acid, 50.0 grams of sodium pyrophosphate (available from Aldrich Chemical Company, Milwaukee, Wis.), and 500 grams of aluminum hydroxide powder (Disperal™ Alumina Powder, available from CONDEA Vista Company, Houston, Tex.) for 30 minutes to create an alumina slurry. A 3168 gram quantity of zinc oxide powder (available from Zinc Corporation, Monaca, Pa.), a 432 gram quantity of diatomaceous earth (Celite™ Filter Cell, available from Manville Sales Corporation, Lampoc, Calif.), and an 80 gram quantity of microcrystalline cellulose (Lattice™ NT-100, available from FMC Corporation, Newark, Del.) were added to the alumina slurry and subsequently mixed with a Cowles dissolver for 15 minutes to create a sorbent base slurry.

The sorbent base slurry was then formed into sorbent base particulate using a counter-current spray drier (Niro Mobile Minor Spray Dryer, available from Niro Inc., Columbia, Md.). The sorbent base slurry was charged to the spray drier wherein it was contacted in a particulating chamber with air flowing through the chamber. The air flowing through the chamber had an inlet temperature of approximately 310° C. and an outlet temperature of approximately 130° C., and operated to partially dry the sorbent base slurry into a sorbent base particulate. The sorbent base particulate was then sieved and the particulate passing through the 70 mesh sieve but retained above the 170 mesh sieve was retained. The −70/+170 sorbent base particulate was then placed in an oven and dried by ramping the oven temperature at 2° C./min to 150° C. and holding at 150° C. for 3 hours. The dried particulate was then calcined by ramping the oven temperature at 3° C./min to 635° C. and holding at 635° C. for 1 hour.

A 151 gram quantity of the sieved, dried, and calcined sorbent base particulate was loaded into a Quartz reactor (2″×20″) and heated to 870° C. A mixture of water and air was charged to the 870° C. reactor to steam-treat the sorbent base particulate. The flow rate of water to the reactor was 1.0 ml/min and the flow rate of air was approximately 350 ml/min. The sorbent base particulate was steamed under these conditions for 6 hours.

After steaming, 150 grams of the particulate was impregnated with an aqueous solution containing 44.56 grams of nickel nitrate hexahydrate that was dissolved in 44.56 grams of water using incipient wetness techniques. The nickel promoted sorbent was then placed in an oven and dried by ramping the oven temperature at 2° C./min to 150° C. and holding at 150° C. for 3 hours. The dried sorbent was then calcined by ramping the oven temperature at 3° C./min to 635° C. and holding at 635° for 1 hour.

The resulting steam-treated sorbent was designated Sorbent B.

### EXAMPLE II

The attrition resistance of Sorbents A and B was then determined using the attrition testing apparatus shown in FIGS. 1-3. The attrition test was performed by first charging 50 grams of the sorbent to the stainless-steel catalyst tube (1.5 “I.D. 28” length). The fines collection vessel was then weighed empty to obtain a tare weight. Room temperature air at 75 psig and 15CF/H was the charged to the bottom of the catalyst tube. The upward flow of air through the catalyst tube agitated the sorbent particulates and thereby caused portions of the particulates to be attrited into fines. The air flowing through the catalyst tube carried the fines, but not the larger-sized particulates, to the fines collection vessel where they were trapped for later measurement.

The collection vessel was removed and weighed after 1 and 5 hours of operation to obtain a 1-hour and 5-hour gross weight. The 1 and 5 hour percent attrition values were calculated using the following formula:

$$\% Attrition \text{1,5} = 100 \times \frac{Gross Weight \text{1,5} - Tare Weight}{50}$$

Table 1 summarizes the attrition test results for Sorbents A and B after 1 and 5 hours.

TABLE 1
ATTRITION TEST RESULTS

| | 1-Hour % Attrition | 5-Hour % Attrition |
|---|---|---|
| Sorbent A | 5.0% | 49.3% |
| Sorbent B | 7.0% | 23.8% |

Table 1 demonstrates that a steam-treated sorbent (Sorbent B) comprising a promoter, zinc oxide, silica, and alumina has improved long term attrition resistance verses a similarly prepared non-steam-treated sorbent (Sorbent A).

### EXAMPLE III

Sorbent B was modified to contain an additional amount of the promoter. Sorbent B was subjected to two more incipient wetness impregnations, each using a solution containing 29.71 grams of nickel nitrate hexahydrate and 6 grams of distilled water. For each impregnation, the solution was sprayed on 50 grams of the sorbent particulate, followed by drying and calcining. The drying was accomplished by placing the impregnated sorbent into an oven and ramping the oven temperature at 3° C./min to 150° C. and holding at 150° C. for 1 hour. Calcining was conducted by ramping the oven temperature at 5° C./min to 635° C. and holding at 635° C. for 1 hour.

The resulting sorbent contained approximately 30 weight percent nickel and was designated Sorbent C.

### EXAMPLE IV

Sorbent C (steam-treated) was then reactor tested under desulfurization conditions.

A 10 gram quantity of −50/+325 mesh Sorbent C was placed in a reactor (1 inch I.D. fluidized bed reactor with clam shell heater) and heated to 700° F. while nitrogen was charged to the reactor at 240 cc/min. The nitrogen flow was then terminated and Sorbent C was reduced with hydrogen flowing at 300 cc/min at a temperature of 689° F. for a period of 65 minutes. Catalytically cracked gasoline (CCG) (345 ppmw sulfur), nitrogen, and hydrogen were then simultaneously charged to the reactor at 13.4 ml/hr, 150 cc/min, and 150 cc/min respectively. After 1 hour, a 8.26 gram effluent sample was taken from the 712° F. reactor and was designated Sample 1A. After 2 hours, a 10.71 gram effluent sample was taken from the 730° F. reactor and was designated Sample 2A. After 3 hours, a 7.82 gram effluent sample was taken from the 715° F. reactor and was designated Sample 3A. After 4 hours, a 9.80 gram effluent sample was taken from the 710° F. reactor and was designated Sample 4A. After 5 hours, a 10.91 gram effluent sample was taken from the 710° F. reactor and was designated Sample 5A.

CCG flow to the reactor was then terminated and the sulfurized sorbent was regenerated with air (60 cc/min) and nitrogen (240 cc/min) at a temperature of about 900° F. for 115 minutes. The reactor temperature was then reduced to about 700° F. and the regenerated sorbent was reduced with hydrogen 300 cc/min for about 95 minutes. The CCG, nitrogen, and hydrogen were then simultaneously charged to the reactor at 13.4 ml/hr, 150 cc/min, and 150 cc/min, respectively. The reactor bed temperature was then maintained between 695° F. and 701° F. Effluent samples were taken at 3 hourly increments and were designated Samples 1B-3B.

CCG flow to the reactor was then terminated and the sulfurized sorbent was regenerated and reduced in substantially the same manner as described above. CCG, nitrogen, and hydrogen were then charged to the reactor, as described above, and the reactor temperature was maintained between 697° F. and 704° F. Effluent samples were taken at 4 hourly increments and were designated Samples 1C-4C.

CCG flow to the reactor was then terminated and the sulfarized sorbent was regenerated and reduced in substantially the same manner as described above. CCG, nitrogen and hydrogen were then charged to the reactor, as described above, and the reactor temperature was maintained between 711° F. and 724° F. Effluent samples were designated Samples 1D-4D.

Samples 1A-5A (Cycle A), 1B-3B (Cycle B), 1C-4C (Cycle C), and 1D-4D (Cycle D) were analyzed for sulfur content using x-ray fluorescence. The results are summarized in Table 2.

TABLE 2
Desulfurization of CCG (345) with Steam-Treated Sorbent C

| | Cycle A | | | |
|---|---|---|---|---|
| | (ppmw | Cycle B | Cycle C | Cycle D |
| Sample | Sulfur) | (ppmw Sulfur) | (ppmw Sulfur) | (ppmw Sulfur) |
| 1 | <5 | <5 | <5 | 10 |
| 2 | <5 | 5 | <5 | 15 |
| 3 | <5 | 15 | <5 | 15 |
| 4 | 5 | — | <5 | 15 |
| 5 | 10 | — | — | — |

Table 2 demonstrates that a steam-treated sorbent comprising a promoter, zinc oxide, alumina, and silica is very effective for removing sulfur from cracked-gasoline.

Reasonable variations, modifications, and adaptations can be made within the scope of this disclosure and the appended claims without departing from the scope of this invention.

What is claimed is:

1. A sorbent composition suitable for removing sulfur from a hydrocarbon-containing fluid, said sorbent composition comprising:
a reduced-valence promoter; and
a steam-treated support.

2. A sorbent composition in accordance with claim 1 wherein said steam-treated support comprises zinc oxide.

3. A sorbent composition in accordance with claim 2 wherein said reduced-valence promoter comprises a metal selected from the group consisting of nickel, cobalt, iron, manganese, copper, zinc, molybdenum, tungsten, silver, tin, vanadium, antimony, and combinations thereof.

4. A sorbent composition in accordance with claim 3 wherein said reduced-valence promoter has a valence of less than 2.

5. A sorbent composition in accordance with claim 1 wherein said steam-treated support comprises zinc oxide, alumina, and silica.

6. A sorbent composition in accordance with claim 5 wherein said reduced-valence promoter comprises nickel.

7. A sorbent composition in accordance with claim 6 wherein said zinc oxide is present in the range of from about 10 to about 90 weight percent, said silica is present in an amount in the range of from about 5 to about 85 weight percent, said alumina is present in an amount in the range of from about 1 to about 30 weight percent, and said reduced-valence promoter is present in an amount in the range of from about 0.5 to about 50 weight percent.

8. A sorbent composition in accordance with claim 7 wherein said reduced-valence promoter has a valence of zero.

9. A sorbent composition in accordance with claim 1 wherein said steam-treated support comprises zinc oxide, alumina, silica, zinc silicate, and zinc aluminate.

10. A sorbent composition in accordance with claim 9 wherein said steam-treated support has been steam-treated under conditions sufficient to form said zinc silicate from at least a portion of said zinc oxide and said silica.

11. A sorbent composition in accordance with claim 10 wherein said steam-treated support has been steam-treated under conditions sufficient to form said zinc aluminate from at least a portion of said zinc oxide and said alumina.

12. A sorbent composition in accordance with claim 9 wherein said steam-treated support has been steam-treated at a temperature in the range of from about 400° C. to about 1500° C. and for a period in the range of from about 0.5 hours to about 24 hours.

13. A sorbent composition in accordance with claim 12 wherein said reduced-valence promoter comprises nickel.

14. A sorbent composition in accordance with claim 13 wherein said sorbent composition is a particulate in the form of a microsphere.

15. A sorbent composition in accordance with claim 14 wherein said microsphere has a mean particle size in the range of from about 1 micrometer to about 500 micrometers.

16. A sorbent composition in accordance with claim 15 wherein said reduced-valence promoter has a valence of zero.

17. A sorbent composition in accordance with claim 16 wherein said sorbent composition has a 5-hour attrition percentage value of less than 30 percent.

18. A process of making a sorbent composition, said process comprising the steps of:
(a) admixing a first support component and a second support component to provide a support mix;
(b) particulating the support mix to provide a support particulate;
(c) steam-treating said support particulate to provide a steam-treated particulate;
(d) incorporating said steam-treated particulate with a promoter to provide a promoted particulate having an unreduced promoter; and
(e) reducing said promoted particulate to provide a reduced sorbent composition having a reduced-valence promoter.

19. A process in accordance with claim 18 wherein said first support component comprises zinc oxide and said second support component comprises alumina and silica.

20. A process in accordance with claim 19 wherein said steam-treating is conducted at conditions sufficient to form zinc silicate from at least a portion of said zinc oxide and said silica present in said support particulate.

21. A process in accordance with claim 19 wherein said steam-treating is conducted at a temperature sufficient to form zinc aluminate from at least a portion of said zinc oxide and said alumina present in said support particulate.

22. A process in accordance with claim 19 wherein said steam-treating is conducted at a temperature in the range of from about 400° C. to about 1500° C. and for a period in the range of from about 0.5 hours to about 24 hours.

23. A process in accordance with claim 22 wherein said reduced-valence promoter component has a valence which is less than the valence of said unreduced promoter.

24. A process in accordance with claim 23 wherein said promoter comprises nickel.

25. A process in accordance with claim 24 wherein said reduced-valence promoter has a valence of less than 2.

26. A process in accordance with claim 18 wherein said support particulate is dried and calcined before steam-treating.

27. A process in accordance with claim 18 wherein said promoted particulate is dried and calcined before reducing.

28. A process in accordance with claim 18 wherein said steam treating is conducted at a temperature in the range of from about 750° C. to about 1,000° C. and for a period in the range of from about 4 hours to about 10 hours.

29. A process in accordance with claim 18 wherein said promoter comprises nickel.

30. A process in accordance with claim 29 wherein said reduced-valence promoter has a valence of less than 2.

31. A process in accordance with claim 29 wherein said reduced-valence promoter has a valence of zero.

32. A composition prepared by the process of claim 17.

33. A composition prepared by the process of claim 30.

34. A process for removing sulfur from a hydrocarbon-containing fluid stream, said process comprising the steps of:
(a) contacting said hydrocarbon-containing fluid stream with a sorbent composition comprising a reduced-valence promoter and a steam-treated support in a desulfurization zone under conditions such that there is formed a desulfurized fluid stream and a sulfurized sorbent;
(b) separating said desulfurized fluid stream from said sulfurized sorbent;
(c) regenerating at least a portion of the separated sulfurized sorbent in a regeneration zone so as to remove at least a portion of the sulfur therefrom and provide a desulfurized sorbent;
(d) reducing said desulfurized sorbent in an activation zone to provide a reduced sorbent composition which will affect the removal of sulfur from said hydrocarbon-containing fluid stream when contacted with the same; and
(e) returning at least a portion of said reduced sorbent composition to said desulfurization zone.

35. A process in accordance with claim 34 wherein said steam-treated support component comprises zinc oxide, alumina, and silica.

36. A process in accordance with claim 35 wherein said reduced-valence promoter comprises a metal selected from the group consisting nickel, cobalt, iron, manganese, copper, zinc, molybdenum, tungsten, silver, tin, vanadium, antimony, and combinations thereof.

37. A process in accordance with claim 36 wherein said sorbent composition comprises said zinc oxide in an amount in the range of from about 10 to about 90 weight percent, said alumina in an amount in the range of from about 1 to about 30 weight percent, said silica in an amount in the range of from about 5 to about 85 weight percent, and said reduced-valence promoter component in an amount in the range of from about 0.5 to about 50 weight percent.

38. A process in accordance with claim 37 wherein said sorbent composition further comprises zinc silicate.

39. A process in accordance with claim 38 wherein said sorbent composition further comprises zinc aluminate.

40. A process in accordance with claim 39 wherein said reduced-valence promoter component has a valence of less than 2.

41. A process in accordance with claim 40 wherein said reduced-valence promoter component comprises nickel.

42. A process in accordance with claim 34 wherein said contacting is carried out at a temperature in the range of from about 100° F. to about 1000° F. and at a pressure in the range of from about 15 to about 1500 psia.

43. A process in accordance with claim 42 wherein said regeneration is carried out at a temperature in the range of from about 0° F. to about 1500° F. and a pressure in the range of from about 25 to about 500 psia.

44. A process in accordance with claim 43 wherein there is employed air as a regeneration agent in said regeneration zone.

45. A process in accordance with claim 34 wherein said desulfurized sorbent is subjected to reduction with hydrogen in said activation zone, wherein during reduction said activation zone is maintained at a temperature in the range of from about 100° F. to about 1500° F. and a pressure in the range of from about 15 to about 1500 psia.

46. A process in accordance with claim 34 wherein the separated sulfurized sorbent is stripped prior to introduction into said regeneration zone.

47. A process in accordance with claim 34 wherein said desulfurized sorbent is stripped prior to introduction to said activation zone.

48. A process in accordance with claim 34 wherein said reduced-valence promoter has a valence of less than 2.

49. A process in accordance with claim 34 wherein said reduced-valence promoter has a valence of zero.

50. A process in accordance with claim 49 wherein said reduced-valence promoter comprises nickel.

51. A process in accordance with claim 34 wherein said hydrocarbon-containing fluid stream is cracked-gasoline.

52. A process in accordance with claim 34 wherein said hydrocarbon-containing fluid stream is diesel.

53. The product produced by the process of claim 51.

54. The product produced by the process of claim 52.
